(19) United States
(12) Patent Application Publication
(10) Pub. No.: US 2015/0229764 A1
(43) Pub. Date: Aug. 13, 2015

(54) CALL METHOD AND INFORMATION PROCESSING APPARATUS

(71) Applicant: FUJITSU LIMITED, Kawasaki-shi (JP)

(72) Inventors: Koichi Shiga, Mishima (JP); Yoshinori Shimada, Ohta (JP); Taku Motonaga, Shinagawa (JP)

(21) Appl. No.: 14/612,796

(22) Filed: Feb. 3, 2015

(30) Foreign Application Priority Data
Feb. 13, 2014 (JP) 2014-025278

(51) Int. Cl. H04M 3/48; H04W 4/02; G06Q 10/10

(52) U.S. Cl. CPC H04M 3/48; G06Q 10/1095; H04W 4/027

(57) ABSTRACT

A storage unit is configured to store booking information of a call to a first user and a second user by means of a first client device utilized by the first user and a second client device utilized by the second user. A computing unit stores such booking information acquired from the first client device, in the storage unit. A computing unit acquires an availability of the second user which is determined on the basis of a current position and an acceleration detected by the second client device, and executes the booked call in response to a change of the availability of the second user.

### CROSS-REFERENCE TO RELATED APPLICATION

This application is based upon and claims the benefit of priority of the prior Japanese Patent Application No. 2014-025278, filed on Feb. 13, 2014, the entire contents of which are incorporated herein by reference.

### FIELD

The embodiments discussed herein relate to a call method and an information processing apparatus.

### BACKGROUND

The information processing system is currently utilized for communication between users. For example, client devices run message transmission software (sometimes referred to as “messenger”) to transmit messages between users using the client devices. For message transmission between users, there are various methods such as voice call, video meeting, and text chat.

When users start communication, one user calls another user, using a client device. However, it might be a bad time for the called user. In consideration of the above, an information management server that provides user's availability information of whether or not a user is able to reply has been proposed. When the information management server receives a second terminal user's request for acquiring a first terminal user's availability of whether or not the first terminal user is able to reply, the information management server determines the first terminal user's availability of whether or not the first terminal user is able to reply, on the basis of position information of the first terminal and schedule information of the first terminal user, and provides the second terminal with the first terminal user's availability.

Also, another proposal is that, if a person, who has received a phone call from another person, states that he or she will call back, with a telephone terminal device, the telephone terminal device outputs a guidance message that prompts a callback when the telephone terminal device gets a predetermined distance away from the position where the statement was made.

Further, another proposal is a communication terminal which, upon detecting that the current time reaches a date and time set in schedule data, changes availability information delivered to other communication terminals, according to schedule (a schedule record name such as an office meeting, and whether or not one can reply to a phone call or an e-mail).

See, for example, Japanese Laid-open Patent Publications Nos. 2008-60683, 2002-290534, and 2009-88702.

In the above proposals, a user who wants to make a contact to another person is able to confirm in advance the other person's availability of whether or not the person is able to reply, before deciding whether to call the person. However, when the person is unable to reply, the user has to take effort to keep trying to confirm the person's availability until the person becomes contactable. On the other hand, the person may be notified of a guidance message for callback, which prompts the person to call back the user at a good time. However, even if the guidance message is transmitted, communication between users is not started without the person's call operation, for example, due to a situation that does not allow the person to communicate by voice call. Thus, the problem is how to realize a scheme which appropriately determines a good time for users to smoothly start communication between the users.

### SUMMARY

According to one aspect, there is provided a call method of calling up users at start of message transmission in a system including a plurality of devices utilized by a plurality of users and an information processing apparatus configured to support transmission of a message between the users by means of the devices. The method includes: booking, by a first device utilized by a first user, a call to the first user and a second user by means of the first device and a second device utilized by the second user, in the information processing apparatus; detecting, by the second device, a current position and an acceleration of the second device to determine an availability of the second user based on the current position and the acceleration; and acquiring, by the information processing apparatus, the availability of the second user and executing the booked call in response to a change of the availability of the second user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system of a first embodiment;

FIG. 2 illustrates an information processing system of a second embodiment;

FIG. 3 illustrates exemplary hardware of a management server;

FIG. 4 illustrates exemplary hardware of a mobile phone;

FIG. 5 illustrates exemplary software of an information processing system;

FIG. 6 illustrates an example of an account management table;

FIG. 7 illustrates an example of a presence management table;

FIG. 8 illustrates an example of a position information table;

FIG. 9 illustrates an example of a meeting time management table;

FIG. 10 illustrates an example of a call booking table;

FIG. 11 illustrates an example of a terminal status management table;

FIG. 12 illustrates an example of a time management table;

FIG. 13 illustrates an example of a measurement table;

FIG. 14 illustrates an example of a reference value table;

FIGS. 15A, 15B, and 15C illustrate examples of acceleration pattern information;

FIG. 16 is a flowchart illustrating an example of an inside-or-outside-company determination by a client;

FIG. 17 is a flowchart illustrating an example of monitoring of an acceleration and a position by a client;

FIG. 18 is a flowchart illustrating an example of meeting determination by a client;

FIG. 19 is a flowchart illustrating an example of determination of travel status by a client;

FIG. 20 is a flowchart illustrating an example of a call process by a management server;

FIG. 21 is a sequence diagram illustrating an example of a sequence of a call process; and

FIG. 22 is a flowchart illustrating another example of a call process by a management server.

### DESCRIPTION OF EMBODIMENTS

Several embodiments will be described below with reference to the accompanying drawings, wherein like reference numerals refer to like elements throughout.

### First Embodiment

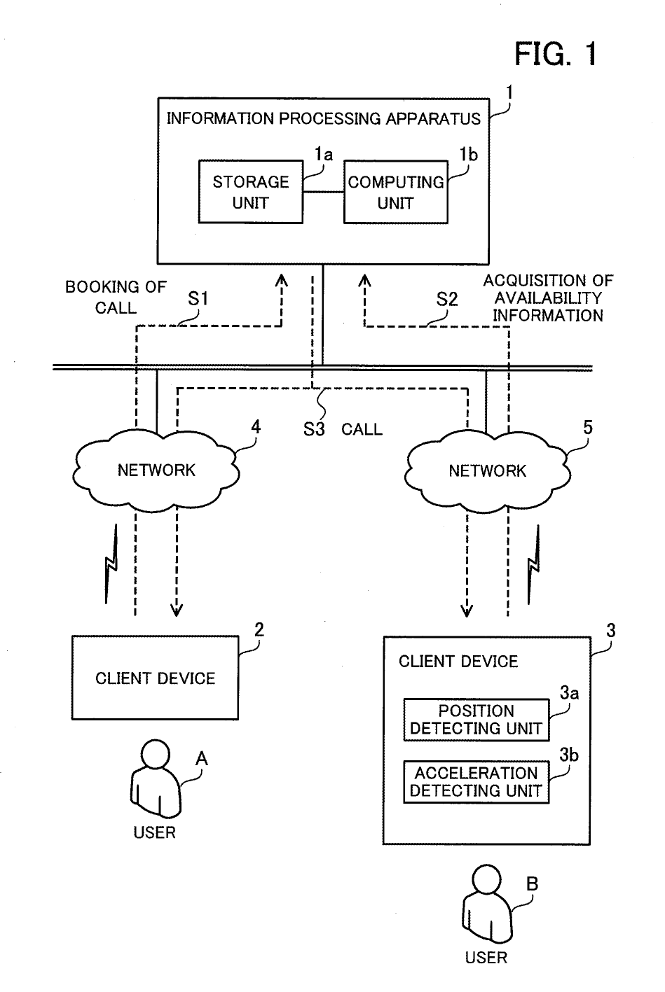

FIG. 1 illustrates an information processing system of the first embodiment. The information processing system of the first embodiment includes an information processing apparatus 1 and client devices 2 and 3. The client device 2 (first device) is utilized by a user A (first user). The client device 3 (second device) is utilized by a user B (second user). The client devices 2 and 3 may be a computer, a tablet terminal device, a mobile phone, or the like.

The client device 2 is carried by user A and travels around various areas (for example, an area inside a company, an area outside a company) together with user A. Likewise, the client device 3 is carried by user B and travels around various areas together with user B. The client devices 2 and 3 are capable of communicating with the information processing apparatus 1 via networks 4 and 5 that are built in the area where the client devices 2 and 3 are traveling. For example, the client device 2 communicates with the information processing apparatus 1 via the network 4. The client device 3 communicates with the information processing apparatus 1 via the network 5.

The information processing apparatus 1 supports transmission (communication) of a message between users A and B by means of the client devices 2 and 3. For example, the client device 2 transmits a call request to the information processing apparatus 1. The call request specifies the client device 3 or user B. The information processing apparatus 1 causes the client device 3 to call up user B in response to the request. If user B replies to the call, the transmission of messages starts between users A and B by means of the client devices 2 and 3. Methods such as voice call, video phone (web meeting), and text chat may be utilized for transmitting messages. Note that the transmission of messages may be performed between three or more users.

The information processing apparatus 1 includes a storage unit 1a and a computing unit 1b. The storage unit 1a may be a storage device such as a RAM (random access memory) and an HDD (hard disk drive). The computing unit 1b may be a processor such as a CPU (central processing unit) and an FPGA (field programmable gate array). The information processing of the first embodiment may be realized by executing a program stored in the storage unit 1a by the computing unit 1b.

The storage unit 1a stores booking information of calls to a plurality of users by means of a plurality of client devices. For example, user B may be busy (for example, visiting a customer) when user A wants to start transmitting a message to user B. In this case, the client device 2 books a call to user A and user B who is called, in the information processing apparatus 1. The booking information includes identification information of the client devices 2 and 3.

For example, the information processing apparatus 1 may manage presence of users A and B (i.e., situations in which users A and B are in) in an integrated manner, based on information acquired from the client devices 2 and 3, so as to share the presence between users A and B. In this way, user A is able to confirm the presence of user B, using the client device 2, and operate the client device 2 to book a call when user B is busy.

The computing unit 1b stores booking information acquired from the client device 2 in the storage unit 1a. The computing unit 1b acquires availability information indicating the availability of user B (hereinafter, simply referred to as “availability of user B”) from the client device 3. The availability of user B is determined on the basis of a current position and an acceleration of the client device 3. For example, the computing unit 1b may acquire the availability of user B on a predetermined cycle (at time intervals).

Here, the client device 3 includes a position detecting unit 3a and an acceleration detecting unit 3b. The position detecting unit 3a detects a current position of the client device 3 by a global positioning system (GPS) function, for example. The acceleration detecting unit 3b detects an acceleration caused by a motion of the client device 3. The client device 3 continually determines an availability of user B, on the basis of the current position and the acceleration detected by the position detecting unit 3a and the acceleration detecting unit 3b.

For example, the client device 3 determines that user B stays at a customer's office on the basis of a current position of user B, and then determines an availability of user B, such as whether or not user B is busy (for example, in a meeting), on the basis of an acceleration of user B. More specifically, the client device 3 determines that, if the change of the acceleration is relatively small, user B sits in a meeting, and if the change of the acceleration is relatively large, user B travels after the end of a meeting. Also, the client device 3 determines that user B stays outside on the basis of the current position of user B, and then determines whether or not user B is busy (for example, traveling by a public transportation system, driving a car, etc.) on the basis of the pattern of the acceleration.

With reference to the booking information stored in the storage unit 1a, the computing unit 1b executes a booked call to users A and B in response to a change of the availability of user B, which is acquired from the client device 3. A call to user A is performed using the client device 2. A call to user B is performed using the client device 3.

For example, when the availability of user B changes from “meeting at a customer's office” to “end of meeting”, the computing unit 1b causes the client devices 2 and 3 to call up users A and B. Alternatively, when the availability of user B changes from “driving a car” to “traveling by foot”, the computing unit 1b may cause the client devices 2 and 3 to call up users A and B. Users A and B reply to the call, in order to start transmission of a message by means of the client devices 2 and 3.

According to the information processing system of the first embodiment, a call to users A and B by means of the client devices 2 and 3 is booked by the client device 2 in the information processing apparatus 1 (step S1). The client device 3 detects a current position and an acceleration of the client device 3 and determines the availability of user B on the basis of the current position and the acceleration. The information processing apparatus 1 acquires the availability of user B (step S2). The information processing apparatus 1 executes the booked call in response to a change of the availability of user B (step S3). Thereby, a call to the users is performed at an appropriate time.

Determination accuracy of an availability of user B might deteriorate, when the availability of user B is determined based on only position information of the client device 3, for example. This is because the position information alone is sometimes insufficient for understanding the actual behavior of user B. However, when a user continually moves around in a customer's office, an unbusy situation may be determined, for example. Also, when a user utilizes a public transportation system or drives a car outside a building, a busy situation may be determined. Thus, the availability of the user is appropriately determined in consideration of the current motion of the user, by using acceleration information. Users A and B are called at appropriate times in view of the user's availability determined as above, so that users A and B are able to smoothly start the communication. Here, both of users A and B are called, and thereby user A is not forced to take effort to continually confirm the availability of user B.

Note that the client device 3 may determine the availability of user B, by using schedule information of user B additionally. For example, during a time period of a meeting on the schedule, position information may be prioritized over acceleration information to determine the availability of user B. During a time period after the end of a meeting on the schedule, acceleration information may be prioritized over position information to determine the availability of user B. This enhances determination accuracy of the user's availability.

Also, the information processing apparatus 1 may acquire the availability of user A from the client device 2 and execute a booked call at an appropriate time in view of the availability of user A. For example, a call may be executed at a time when user A returns to his or her own desk in the company from outside. Communication is further facilitated by executing a call at a good time for both of users A and B.

Further, if there are a plurality of candidates (for example, voice call, video phone, text chat, etc.) as a method for transmitting a message, the information processing apparatus 1 may accept information specifying which method to use, from the client device 2 or the client device 3. For example, the specifying information may be accepted when the client device 2 makes a booking, or when a call is executed. Alternatively, the information processing apparatus 1 may select a method for transmitting a message from among a plurality of candidates, on the basis of the availability of user A or user B. For example, text chat may be selected when user B is in a customer's office or when user B utilizes a public transportation system, and voice call may be selected when user B travels by foot. Communication is facilitated by selecting a message transmission method that is easy for a user to utilize, on the basis of availabilities of the users.

### Second Embodiment

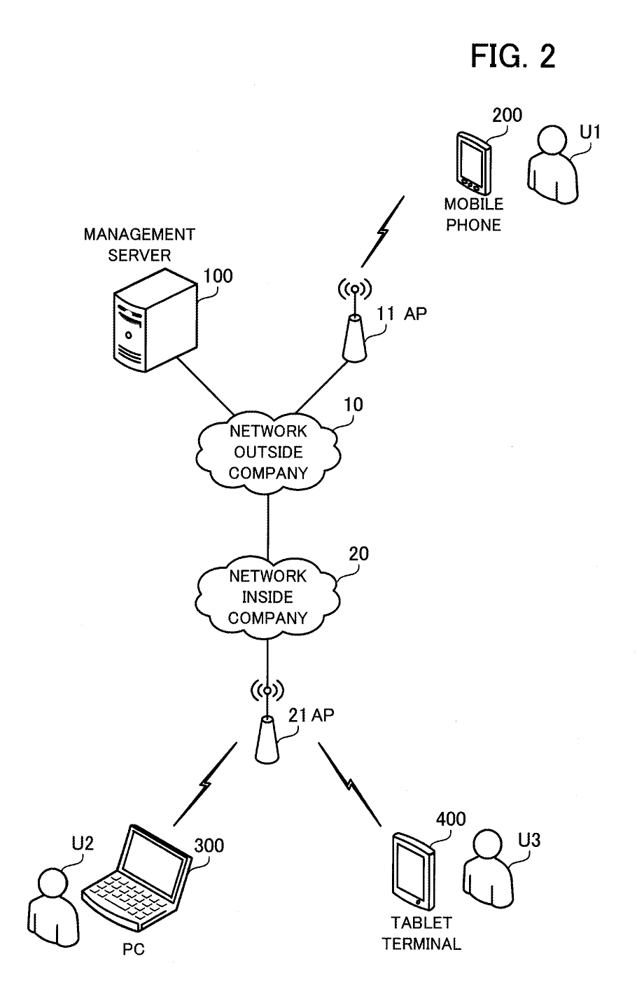

FIG. 2 illustrates an information processing system of the second embodiment. The information processing system of the second embodiment includes a management server 100, a mobile phone 200, a personal computer (PC) 300, and a tablet device 400. In the following description, the mobile phone 200, the PC 300, and the tablet device 400 are sometimes referred to as “client” collectively.

The management server 100 is connected to a network 10 that is located outside a company. The network 10 outside the company is a widely utilized network such as the Internet and a wide area network (WAN). For example, the management server 100 may be provided in a data center. The mobile phone 200 is capable of accessing the network 10 outside the company via an access point (AP) 11. The access point 11 is a wireless router capable of wirelessly communicating with the mobile phone 200. The access point 11 may be a wireless base station that communicates with the network 10 outside the company via a mobile communication network.

The PC 300 and the tablet device 400 are capable of accessing a network 20 that is located inside the company via an access point 21. For example, the network 20 inside the company is a local area network (LAN) that is built inside a certain company. The access point 21 is a wireless router capable of wirelessly communicating with the PC 300 and the tablet device 400. Note that the access point 21 and a client may be connected by a wire.

The network 10 outside the company and the network 20 inside the company are connected to each other in a communicable manner. The mobile phone 200 accesses the management server 100 via the network 10 outside the company. The PC 300 and the tablet device 400 access the management server 100 via the network 10 outside the company and the network 20 inside the company.

The management server 100 is a server computer that provides information indicating an availability of a user (sometimes referred to as “presence” or “presence information”). Also, the management server 100 functions as a messenger server that supports transmission of a message between users by means of the mobile phone 200, the PC 300, and the tablet device 400. For example, the management server 100 connects these clients to each other by a technology called 3PCC (3rd Party Call Control) to enable transmission and reception of a message between the clients. The management server 100 enables communication between two users or between three or more users by means of respective clients. A device that supports a video meeting in which a plurality of users participate at a plurality of locations, such as the management server 100, is sometimes referred to as “MCU (Multipoint Control Unit)”.

For example, voice call, video meeting, or text chat may be utilized as a method for transmitting a message. Also, the management server 100 executes operations such as saving a message log. Further, the management server 100 functions as a Web server that provides a predetermined graphical user interface (GUI) and accompanying data for a web browser of each client.

The mobile phone 200 is a portable terminal device utilized by a user U1. The mobile phone 200 may be what is called “smartphone”. The PC 300 is a client computer utilized by a user U2. The PC 300 may be of a desktop type or a laptop type. The tablet device 400 is a tablet terminal device utilized by a user U3.

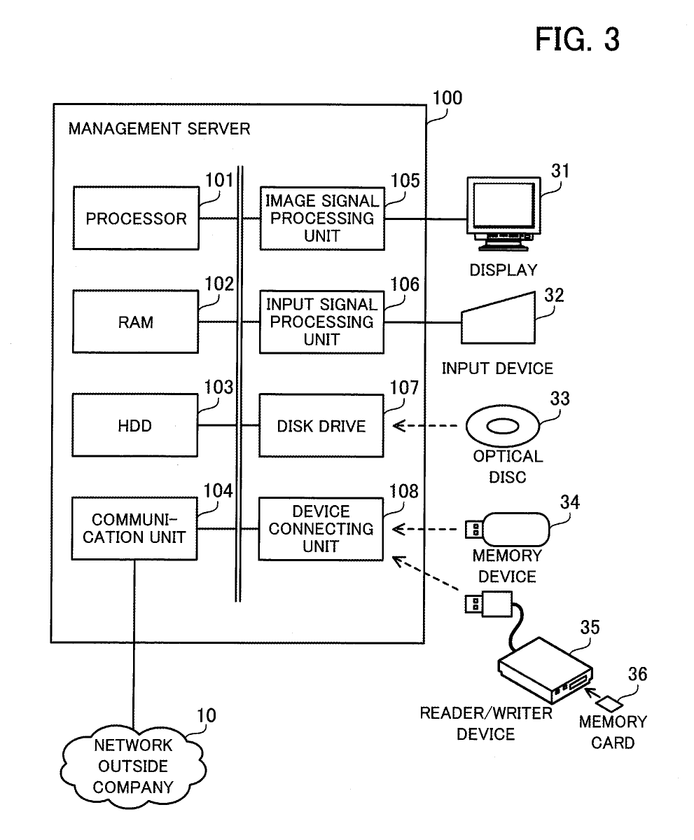

FIG. 3 illustrates exemplary hardware of the management server. The management server 100 includes a processor 101, a RAM 102, an HDD 103, a communication unit 104, an image signal processing unit 105, an input signal processing unit 106, a disk drive 107, and a device connecting unit 108. Each unit is connected to a bus in the management server 100.

The processor 101 controls information processing of the management server 100. The processor 101 is, for example, a CPU, an MPU (Micro Processing Unit), a DSP (Digital Signal Processor), an ASIC (Application Specific Integrated Circuit), an FPGA, or a PLD (Programmable Logic Device). The processor 101 may be a multiprocessor. The processor 101 may be a combination of two or more of a CPU, an MPU, a DSP, an ASIC, an FPGA, and a PLD.

The RAM 102 is a main storage device of the management server 100. The RAM 102 temporarily stores at least a part of operating system (OS) programs and application programs which are executed by the processor 101. Also, the RAM 102 stores various types of data used in processing by the processor 101.

The HDD 103 is an auxiliary storage device of the management server 100. The HDD 103 magnetically writes data into and reads data from a magnetic disk inside the HDD 103. The HDD 103 stores OS programs, application programs, and various types of data. The management server 100 may be equipped with other types of auxiliary storage devices such as a flash memory and an SSD (Solid State Drive). Also, the management server 100 may be equipped with a plurality of auxiliary storage devices.

The communication unit 104 is an interface capable of wirelessly communicating with other computers via the network 10 outside the company. The communication unit 104 may be a wired interface.

The image signal processing unit 105 outputs an image to a display 31 connected to the management server 100, in accordance with a command from the processor 101. The display 31 is, for example, a CRT (Cathode Ray Tube) display or a liquid crystal display.

The input signal processing unit 106 acquires an input signal from an input device 32 connected to the management server 100 and outputs the input signal to the processor 101. The input device 32 is, for example, a keyboard and a pointing device, such as a mouse and a touch panel.

The disk drive 107 is a drive device that utilizes a laser light or the like to read programs and data recorded on an optical disc 33. The optical disc 33 is, for example, a DVD (Digital Versatile Disc), a DVD-RAM, a CD-ROM (Compact Disc Read Only Memory), or a CD-R(Recordable)/RW(ReWritable). The disk drive 107 stores programs and data read from the optical disc 33, in the RAM 102 or the HDD 103, in accordance with a command from the processor 101, for example.

The device connecting unit 108 is a communication interface for connecting peripheral devices to the management server 100. For example, the device connecting unit 108 is connected to a memory device 34 and a reader/writer device 35. The memory device 34 is a recording medium having a communication function with the device connecting unit 108. The reader/writer device 35 is a device that writes data in a memory card 36 or reads data from the memory card 36. The memory card 36 is a recording medium having the shape of a card. The device connecting unit 108 stores programs and data read from the memory device 34 or the memory card 36, in the RAM 102 or the HDD 103, in accordance with a command from the processor 101, for example. Note that the PC 300 is also configured by the same hardware as the management server 100.

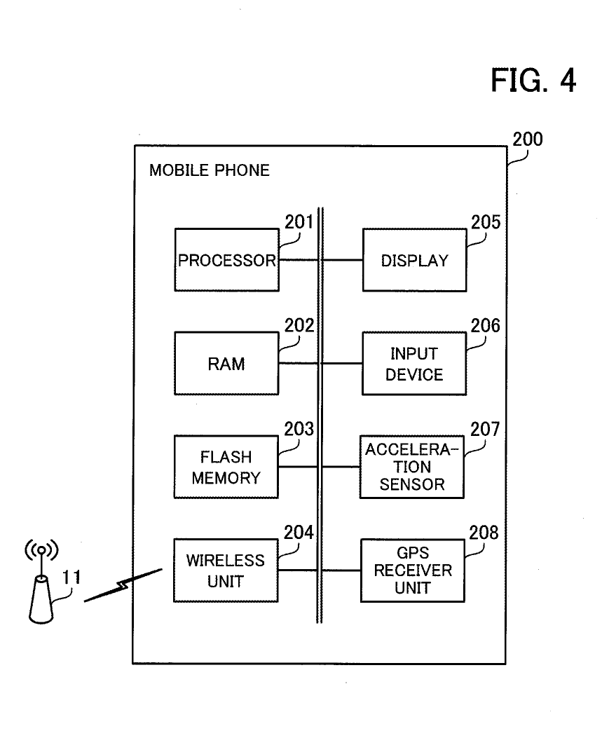

FIG. 4 illustrates exemplary hardware of the mobile phone. The mobile phone 200 includes a processor 201, a RAM 202, a flash memory 203, a wireless unit 204, a display 205, an input device 206, an acceleration sensor 207, and a GPS receiver unit 208. Each unit is connected to a bus in the mobile phone 200.

The processor 201 controls information processing of the mobile phone 200. The processor 201 is, for example, a CPU, an MPU, a DSP, an ASIC, an FPGA, or a PLD. The processor 201 may be a multiprocessor. The processor 201 may be a combination of two or more of a CPU, an MPU, a DSP, an ASIC, an FPGA, and a PLD.

The RAM 202 is a main storage device of the mobile phone 200. The RAM 202 temporarily stores at least a part of OS programs and application programs which are executed by the processor 201. Also, the RAM 202 stores various types of data used in processing by the processor 201.

The flash memory 203 is an auxiliary storage device of the mobile phone 200. The flash memory 203 stores OS programs, application programs, and various types of data. The flash memory 203 may be a portable recording medium which is attachable to and detachable from the mobile phone 200.

The wireless unit 204 is an interface capable of wirelessly communicating with the access point 11. For example, if the access point 11 is a wireless router, the wireless unit 204 is a wireless LAN interface. Also, for example, if the access point 11 is a wireless base station, the wireless unit 204 is a wireless interface for mobile communication. The mobile phone 200 may be equipped with both of the wireless LAN interface and the mobile communication wireless interface. Also, the mobile phone 200 may be equipped with a wired communication interface in addition to or instead of the wireless unit 204, to connect with the access point 11.

The display 205 outputs an image in accordance with a command from the processor 201. The display 205 is, for example, a liquid crystal display or an organic EL (Electro Luminescence) display.

The input device 206 outputs an input signal to the processor 201. The input device 206 is, for example, a button, a touch pad, and a touch panel.

The acceleration sensor 207 is a sensor device for detecting an acceleration in two axis directions on a horizontal plane and in a vertical direction, relative to a ground surface.

The GPS receiver unit 208 is a device that receives a signal from GPS satellites to acquire position information indicating a current position of the GPS receiver unit 208. For example, a latitude and a longitude are measured as the information indicating the current position of the GPS receiver unit 208. Note that the mobile phone 200 may acquire position information of the GPS receiver unit 208 from a wireless base station or the like.

Note that, in addition to the units described above, the mobile phone 200 includes a microphone for telephone conversation, a speaker that produces calling sound and voice of a person with whom a user talks with, a motor that vibrates the mobile phone 200, a camera that captures images for video phone, and other components. Also, the tablet device 400 is configured by the same hardware as the mobile phone 200. Also, the PC 300 may include an acceleration sensor and a GPS receiver unit, in addition to the hardware illustrated in FIG. 3.

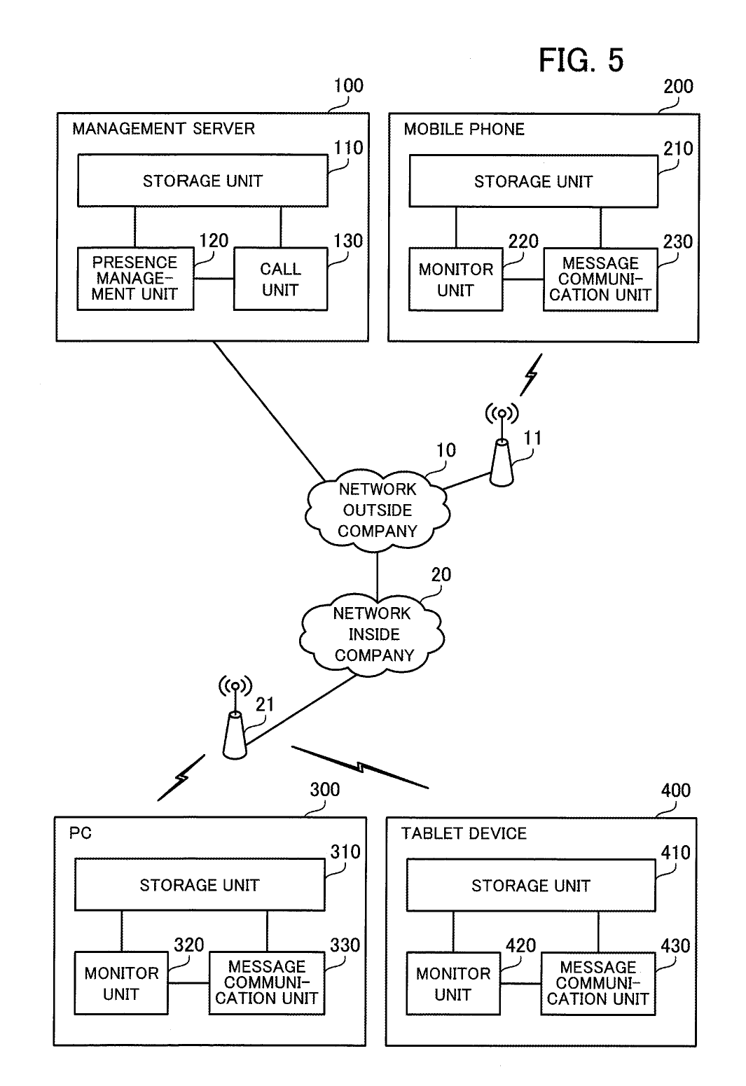

FIG. 5 illustrates exemplary software of the information processing system. A part or all of the units illustrated in FIG. 5 may be a module of a program executed by the processor of each device.

The management server 100 includes a storage unit 110, a presence management unit 120, and a call unit 130. The storage unit 110 stores information used in processing of the presence management unit 120 and the call unit 130. The information stored in the storage unit 110 includes an account management table, a presence management table, a position information table, a meeting time management table, and a call booking table.

The account management table is a table for managing correspondence between users and clients carried by the users, and accompanying information. The presence management table is a table for managing presence of users. The position information table is a table for managing position information of clients. The meeting time management table is a table for managing time schedules of meetings with customers which are held outside a company. The meeting time management table is also a table for managing schedules of users.

The call booking table is a table for managing bookings of calls for starting transmission of messages (hereinafter, simply referred to as “call booking”). For example, in some cases, a certain user wants to make a contact with another user at a certain time, but the other user is busy. In such cases, as described later, the user may operate a client in hand to book a call to the user and the other user in the management server 100. In this case, the management server 100 executes the booked call in response to a change of the presence of the other user.

The presence management unit 120 generates presence of each user, based on the information collected from each client via the network 10 outside the company and the network 20 inside the company, and records the presence of each user in the presence management table. The presence management unit 120 provides each client with the presence recorded in the presence management table. Thereby, a user is able to confirm presence of another user using a client in hand.

When the call unit 130 accepts a call booking from each client, the call unit 130 records the call booking in the call booking table. The call booking includes identification information of a requesting client that requests a booking, identification information of a client of a person who is to be called, and accompanying information. When the call unit 130 detects that the presence of a person who is to be called changes to a situation where the person is able to reply to a call, the call unit 130 requests the requesting client and the client of the person who is to be called, to call up each user. When each user replies to the call, transmission of a message between the users by means of respective clients starts.

The mobile phone 200 includes a storage unit 210, a monitor unit 220, and a message communication unit 230. The storage unit 210 stores various types of information used in processing of the monitor unit 220 and the message communication unit 230. The information stored in the storage unit 210 includes a terminal status management table, a time management table, a measurement table, a reference value table, and acceleration pattern information.

The terminal status management table is a table for managing the presence of user U1. The time management table is a table for managing meeting schedules of user U1. The measurement table is a table for managing acceleration sensor values and GPS data detected by the mobile phone 200. The reference value table is a table for managing predetermined reference values for the acceleration sensor value and the GPS data. The acceleration pattern information includes patterns of temporal change of acceleration sensor value detected by the acceleration sensor 207. The patterns of temporal change of acceleration sensor value may be associated with means for traveling of user U1.

Also, the storage unit 210 stores the information such as a URL (Uniform Resource Locator) and an IP (Internet Protocol) address of the management server 100. Further, the storage unit 210 also stores an encryption key, a network name (Service Set Identifier or SSID) and other information for communicating with the access points 11, 21.

The monitor unit 220 monitors the status of the mobile phone 200 and rewrites the terminal status management table. For example, the monitor unit 220 monitors the next conditions. The first condition is whether or not there is a network either inside or outside a company which the monitor unit 220 can connect with. This monitoring is executed on the basis of accessibility or inaccessibility of the access point 11 (if accessible, the network is outside the company), and accessibility or inaccessibility of the access point 21 (if accessible, the network is inside the company). The second condition is what situation user U1 is in, when the mobile phone 200 is either inside or outside the company. This monitoring is executed on the basis of an acceleration sensor value detected by the acceleration sensor 207 and position information detected by the GPS receiver unit 208, and other information.

When the content of the terminal status management table is updated, the monitor unit 220 notifies the management server 100 of the updated content. Also, when a first user carrying the mobile phone 200 selects a second user whose presence the first user wants to confirm, the monitor unit 220 requests the presence of the selected second user from the management server 100. The monitor unit 220 acquires the presence of the second user from the management server 100 and displays the acquired presence of the second user on the display 205.

The message communication unit 230 is a messenger function for transmitting a message to and receiving a message from the PC 300 or the tablet device 400 via the management server 100. The message communication unit 230 provides communication environment such as voice call, video meeting, and text chat, for the user. For example, in the voice call, the message is audio information. In the video meeting, the message is audio and image information. In the text chat, the message is text information. Also, the message communication unit 230 transmits a call booking to the management server 100, in response to operation of user U1.

The PC 300 includes a storage unit 310, a monitor unit 320, and a message communication unit 330. The tablet device 400 includes a storage unit 410, a monitor unit 420, and a message communication unit 430. The information stored in the storage units 310 and 410 is same as or similar to the information stored in the storage unit 210. The monitor units 320 and 420 have a function that is same as or similar to the monitor unit 220. Note that the monitor unit 320 detects the presence of user U2 and notifies the management server 100 of the presence of user U2. Also, the monitor unit 420 detects the presence of user U3 and notifies the management server 100 of the presence of user U3. The message communication units 330 and 430 have a function that is same as or similar to the message communication unit 230.

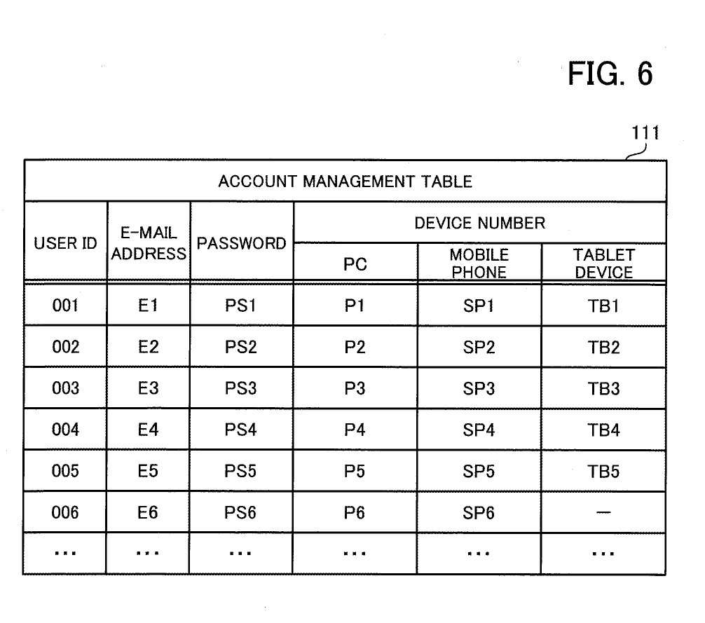

FIG. 6 illustrates an example of the account management table. The account management table 111 is stored in the storage unit 110. The account management table 111 is a collection of records representing user identifier (ID), e-mail address, password, and device number (PC, mobile phone, and tablet device).

User IDs are recorded in the column of user ID. E-mail addresses of users are recorded in the column of e-mail address. For example, a user may receive an e-mail for the user's e-mail address, from the management server 100 or other mail servers, using a predetermined e-mail software executed in each client, and read the received e-mail. Passwords used in user authentication are recorded in the column of password. For example, the user authentication is executed automatically or by having the user input the user ID and the password, when each client starts its access to the management server 100. Device numbers of respective clients are recorded in the column of device number. In the second embodiment, clients are, for example, a PC, a mobile phone, and a tablet device. Hence, device numbers of all clients owned by a user are recorded.

For example, in the account management table 111, entries such as user ID “001”, e-mail address “E1”, password “PS1”, device number (PC) “P1”, device number (mobile phone) “SP1”, and device number (tablet device) “TB1” are recorded. This means that the e-mail address is E1, and the password for authentication is “PS1” with respect to a user (for example, user U1) having user ID “001”. Also, this means that the device number of a PC utilized by user U1 is “P1”, and that the device number of a mobile phone (i.e., mobile phone 200) is “SP1”, and that the device number of a tablet device utilized by user U1 is “TB1”.

Here, a device number is associated with the address of each client. For example, the presence management unit 120 may record correspondence relationship between device numbers and IP addresses of all clients that have accessed the management server 100, in the storage unit 110, in order to use the correspondence relationship in communication with each client. Note that the user ID of user U2 is “002”. The PC utilized by user U2 is the PC 300. The device number of the PC 300 is “P2”. The user ID of user U3 is “003”. The tablet device utilized by user U3 is the tablet device 400. The device number of the tablet device 400 is “TB3”.

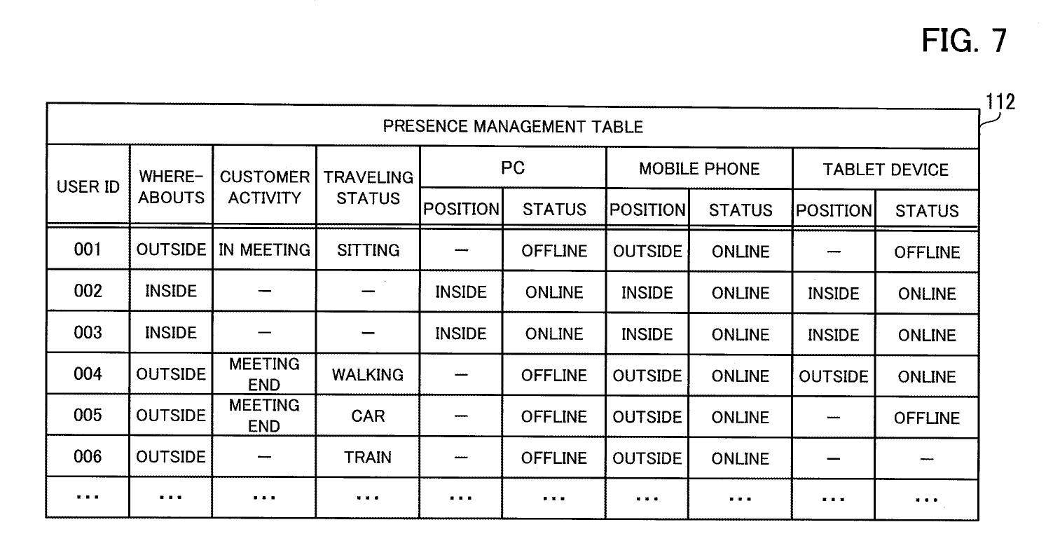

FIG. 7 illustrates an example of the presence management table. The presence management table 112 is stored in the storage unit 110. The presence management table 112 is a collection of records representing user ID, whereabouts, customer activity, travel status, position (i.e., inside or outside the company) and status of PC, position and status of mobile phone, position and status of tablet device.

User IDs are recorded in the column of user ID. Entries indicating whereabouts of users are recorded in the column of whereabouts. For example, entries such as “inside” or “outside” are recorded in the column of whereabouts. “Inside” means that a user is inside a company. “Outside” means that a user is outside a company. Also, “-” (hyphen) means a state in which a client is not utilized, for example, as the power supply of the client is turned off. Also, “outside” is set in the column of whereabouts, when any of the records in the columns of position of PC, position of mobile phone, and position of tablet device is “outside”. On the other hand, “inside” is set in the column of whereabouts, when all of the records in the columns of position of PC, position of mobile phone, and position of tablet device are “inside”. Note that the position of a client that is not owned by a user is not taken into consideration.

Entries indicating whether or not facing a customer are recorded in the column of customer activity. An entry recorded in the column of customer activity is “in meeting” or “meeting end”. “In meeting” means that a user is facing a customer. “Meeting end” means that a user has ended a meeting with a customer. Also, “-” means neither “in meeting” nor “meeting end”.

Entries indicating what means for traveling is utilized by a user (referred to as “travel status”) are recorded in the column of travel status. An entry recorded in the column of travel status is “sitting”, “walking”, “train”, “car”, or “other”. “Sitting” means that a user is sitting. “Walking” means that a user is traveling by foot. “Train” means that a user is traveling by train. “Car” means that a user is traveling by car. “Other” means that a user is in a state other than “sitting”, “walking”, “train”, and “car”. Also, “-” means that a travel status of a user is not monitored.

Entries indicating whether a PC is inside or outside a company are recorded in the column of position of PC. An entry recorded in the column of position is “inside” or “outside”. “Inside” means that a PC is inside a company. “Outside” means that a PC is outside a company. Also, “-” means that no entry is set. No entry is set, when a power supply of a PC is turned off, when a PC is not connected to a network, when a user does not own a PC, and in like situations.

Entries indicating statuses of PCs and availability of users are recorded in the column of status of PC. An entry recorded in the column of status of PC is “online”, “offline”, or “talking”. “Online” means that a user is working at a PC. “Offline” means a state in which a power supply of a PC is turned off, or a PC is not connected to a network, for example. “Talking” means that a user uses a PC to communicate with other users. Also, “-” means that no entry is set. No entry is set, when a user does not own a PC.

Entries set in the columns of position and status of mobile phone and in the columns of position and status of tablet device are same as entries set in the columns of position and status of PC. For example, in the presence management table 112, entries such as user ID “001”, whereabouts “outside”, customer activity “in meeting”, travel status “sitting”, position of PC “-”, status of PC “offline”, position of mobile phone “outside”, status of mobile phone “online”, position of tablet device “-”, and status of tablet device “offline” are recorded. This means that user U1 is sitting in a meeting with a customer, which is held outside a company. Also, this means an offline state of the PC of user U1, and an online state of the mobile phone 200 of user U1, and an offline state of the tablet device of user U1.

Also, for example, in the presence management table 112, entries such as user ID “002”, whereabouts “inside”, customer activity “-”, travel status position of PC “inside”, status of PC “online”, position of mobile phone “inside”, status of mobile phone “online”, position of tablet device “inside”, and status of tablet device “online” are recorded. This means that user U2 is inside a company. Also, this means an online state of the PC 300 of user U2, and an online state of the mobile phone of user U2, and an online state of the tablet device of user U2.

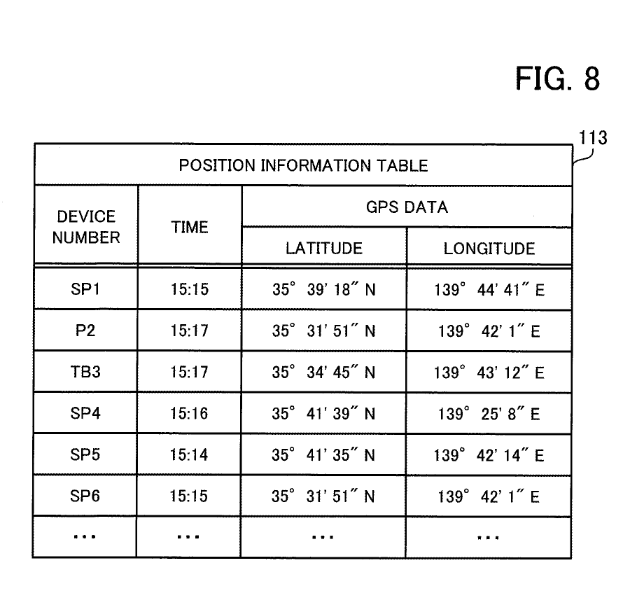

FIG. 8 illustrates an example of the position information table. In the position information table 113, current positions (GPS data) of clients carried by all user are recorded. The position information table 113 is stored in the storage unit 110. The position information table 113 is a collection of records representing device number, time, and GPS data (latitude, longitude).

Device numbers are recorded in the column of device number. Time stamps are recorded in the column of time. Measured values of latitude (north latitude, south latitude) are recorded in the column of latitude. Measured values of longitude (east longitude, west longitude) are recorded in the column of longitude.

For example, in the position information table 113, entries such as device number “SP1”, time “15:15”, latitude “35° 39′ 18″ N”, and longitude “139° 44′ 41″ E.” are recorded. This means that the mobile phone SP1 carried by user U1 is positioned at 35 degrees 39 minutes 18 seconds north latitude and 139 degrees 44 minutes 41 seconds east longitude, at 15:15.

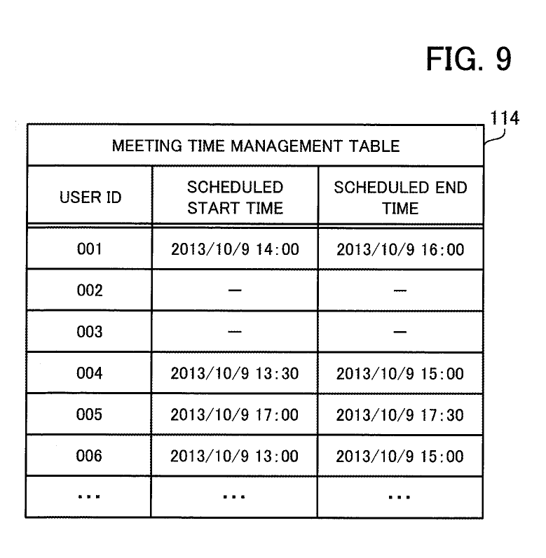

FIG. 9 illustrates an example of the meeting time management table. Time schedules of meetings with customers which are held outside a company are recorded in the meeting time management table 114. The meeting time management table 114 is stored in the storage unit 110. The meeting time management table 114 is a collection of records representing user ID, scheduled start time, and scheduled end time.

User IDs are recorded in the column of user ID. Scheduled start times of meetings are recorded in the column of scheduled start time. Scheduled end times of meetings are recorded in the column of scheduled end time. For example, in the meeting time management table 114, entries such as user ID “001”, scheduled start time “2013/10/9 14:00”, and scheduled end time “2013/10/9 16:00” are recorded. This means that the scheduled start time of a meeting of user U1 is at 14:00 on Oct. 9, 2013, and that the scheduled end time of the meeting is at 16:00 on Oct. 9, 2013.

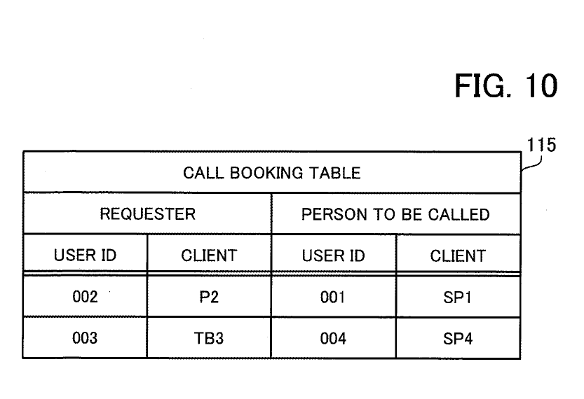

FIG. 10 illustrates an example of the call booking table. Entries for managing call bookings are recorded in the call booking table 115. The call booking table 115 is stored in the storage unit 110. The call booking table 115 is a collection of records representing requester (user ID, client) and person to be called (user ID, client). User IDs of users who are each a requester of a call booking are recorded in the column of user ID of requester. Identification information of clients utilized by requesters of call bookings is recorded in the column of client of requester. User IDs of persons who are to be called are recorded in the column of user ID of person to be called. Identification information of clients utilized by persons who are to be called is recorded in the column of client of person to be called.

For example, in the call booking table 115, entries such as user ID of requester “002”, client of requester “P2”, user ID of person to be called “001”, client of person to be called “SP1” are recorded. This means that the client of the requester is the PC 300 carried by user U2, and that the client of the person to be called is the mobile phone 200 carried by user U1. In other words, this means that the requesting user is user U2, and that the user who is to be called is user U1.

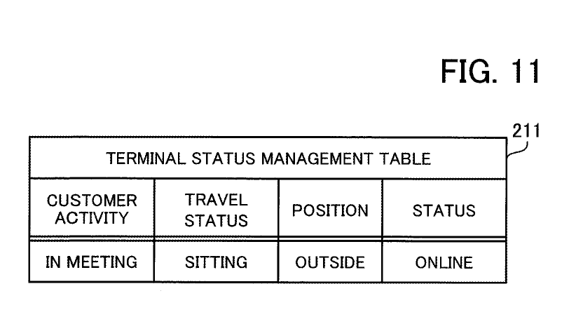

FIG. 11 illustrates an example of the terminal status management table. The terminal status management table 211 is stored in the storage unit 210. The terminal status management table 211 includes records of customer activity, travel status, position, and status.

An entry indicating whether or not facing a customer is recorded in the column of customer activity. An entry indicating a travel status is recorded in the column of travel status. An entry indicating whether user U1 is inside or outside a company is recorded in the column of position. An entry indicating a status of the mobile phone 200 is recorded in the column of status.

For example, in the terminal status management table 211, entries such as customer activity “in meeting”, travel status “sitting”, position “outside”, and status “online” are recorded. This means that user U1 is sitting in a meeting with a customer, which is held outside a company. Also, this means that the mobile phone 200 is in an online state.

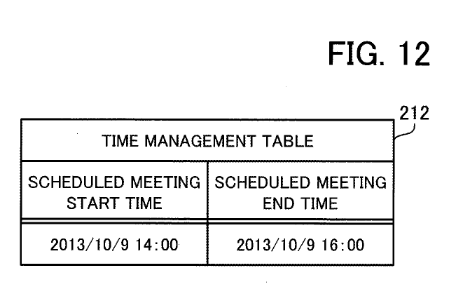

FIG. 12 illustrates an example of the time management table. A scheduled meeting time of the user carrying the mobile phone 200 is recorded in the time management table 212. The time management table 212 is stored in the storage unit 210. The time management table 212 includes records representing a scheduled meeting start time and a scheduled meeting end time.

A scheduled meeting start time is recorded in the column of scheduled meeting start time. A scheduled meeting end time is recorded in the column of scheduled meeting end time. For example, in the time management table 212, entries such as scheduled meeting start time “2013/10/9 14:00” and scheduled meeting end time “2013/10/9 16:00” are recorded. This means that a meeting is scheduled for user U1 carrying the mobile phone 200, and that the scheduled meeting start time is at 14:00 on Oct. 9, 2013 and the scheduled meeting end time is at 16:00 on Oct. 9, 2013.

For example, the mobile phone 200 downloads the meeting time schedule of user U1 from the meeting time management table 114 stored in the management server 100, and records the downloaded meeting time schedule in the time management table 212. Such download is executed, for example, when the mobile phone 200 turns on its power supply and logs in to the management server 100, or when the schedule recorded in the management server 100 is changed.

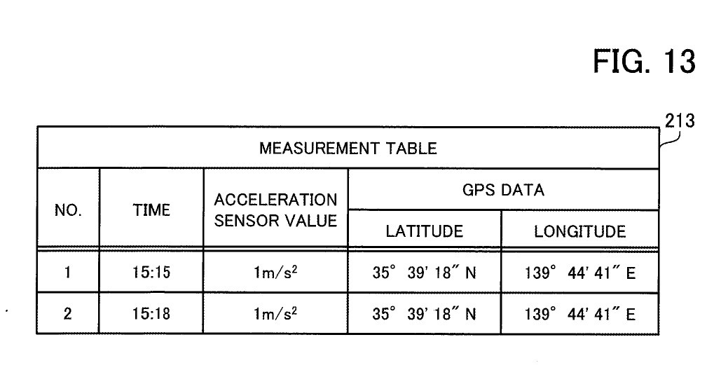

FIG. 13 illustrates an example of the measurement table. Acceleration sensor values and positions measured by the mobile phone 200 are recorded in the measurement table 213. The measurement table 213 is stored in the storage unit 210. The measurement table 213 is a collection of records representing number, time, acceleration sensor value, and GPS data (latitude, longitude).

Numbers for identifying records are recorded in the column of number. Times at which measurements are conducted are recorded in the column of time. Acceleration sensor values are recorded in the column of acceleration sensor value. Measured values of latitude (north latitude, south latitude) are recorded in the column of GPS data (latitude). The measured values of longitude (east longitude, west longitude) are recorded in the column of GPS data (longitude).

For example, in the measurement table 213, entries such as number “1”, time “15:15”, acceleration sensor value “1 m/s²”, latitude “35° 39′ 18″ N”, and longitude “139° 44′ 41″ E” are recorded. This means that the acceleration sensor value is 1 m/s² at 15:15. Also, this means that the mobile phone 200 is positioned at 35 degrees 39 minutes 18 seconds north latitude and 139 degrees 44 minutes 41 seconds east longitude, at 15:15.

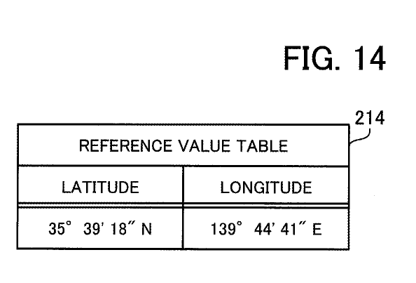

FIG. 14 illustrates an example of the reference value table. The reference value table 214 is the information used to determine the customer activity of the user carrying the mobile phone 200. The reference value table 214 is stored in the storage unit 210. The reference value table 214 includes records of latitude and longitude. A value of latitude (north latitude, south latitude) is recorded in the column of latitude as a reference value. A value of longitude (east longitude, west longitude) is recorded in the column of longitude as a reference value. For example, in the reference value table 214, entries such as latitude “35° 39′ 18″ N”, and longitude “139° 44′ 41″ E” are recorded. This means that the reference value of the latitude is 35 degrees 39 minutes 18 seconds north latitude, and that the reference value of the longitude is 139 degrees 44 minutes 41 seconds east longitude.

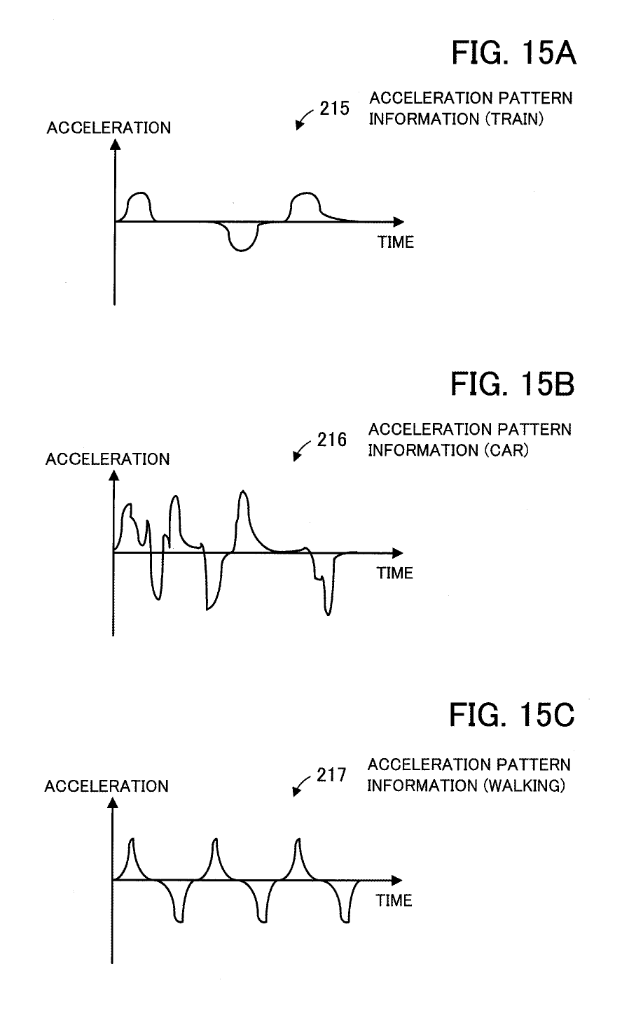

FIGS. 15A, 15B, and 15C illustrate examples of acceleration pattern information. FIG. 15A illustrates acceleration pattern information 215 when traveling by train. FIG. 15B illustrates acceleration pattern information 216 when traveling by car. FIG. 15C illustrates acceleration pattern information 217 when traveling by foot. In the acceleration pattern information 215, 216, and 217, acceleration patterns according to travel statuses of users are illustrated with an acceleration value on the vertical axis and a time on the horizontal axis. The acceleration pattern information 215, 216, and 217 is stored in advance in the storage unit 210.

For example, the acceleration pattern information 215 has the following features. (1) The change of acceleration is cyclic. (2) The amplitude of acceleration is constant. For example, the monitor unit 220 samples acceleration sensor values measured by the acceleration sensor 207 and determines that the travel status of a user is train when the sampled acceleration sensor values (1) changes cyclically and (2) has a constant amplitude.

For example, the acceleration pattern information 216 has the following features. (1) The change of acceleration is not cyclic. (2) The amplitude of acceleration is not constant. (3) The amplitude of acceleration is larger than the amplitude of train. For example, the monitor unit 220 samples acceleration sensor values measured by the acceleration sensor 207 and determines that the travel status of a user is car when the sampled acceleration sensor values (1) changes non-cyclically and (2) has a non-constant amplitude and (3) has an amplitude that is larger than the amplitude of train.

For example, the acceleration pattern information 217 has the following features. (1) The change of acceleration is cyclic. (2) The amplitude of acceleration is constant. (3) The amplitude of acceleration is small. For example, the monitor unit 220 samples acceleration sensor values measured by the acceleration sensor 207 and determines that the travel status of a user is walking when the sampled acceleration sensor values (1) changes cyclically and (2) has a constant amplitude and (3) has a small amplitude.

For example, the monitor unit 220 performs acceleration pattern matching as described below, on the basis of acceleration in the three axes, which is measured by the acceleration sensor 207. When the acceleration sensor 207 measures accelerations along two axes (X axis, Y axis) in a horizontal plane and the vertical axis (Z axis), the acceleration obtained for each axis is corrected by a predetermined method. For example, the gravitational acceleration 9.8 [m/s²] is subtracted from the acceleration along Z axis. Then, the magnitude of the acceleration is calculated from the accelerations along the three axes and is plotted along a time axis. The monitor unit 220 performs matching of a plurality of plotted points to the acceleration pattern information 215, 216, and 217, in order to check which travel status a user is in.

Also, for example, the monitor unit 220 may calculate a linear equation by the least squares method on the basis of the acceleration pattern information 217 and determine that the travel status is walking when the slope of the linear equation is zero allowing a predetermined tolerance. Also, the monitor unit 220 may determine that the travel status is walking, when the intervals of times at which the acceleration value crosses zero is same as the intervals of the times at which the acceleration value crosses zero in the acceleration pattern information 217, allowing a tolerance that is equal to or less than 0.5 second.

Next, the processing procedure in the second information processing system will be described. First, the following description will explain a procedure for determining whether a client is present inside or outside a company.

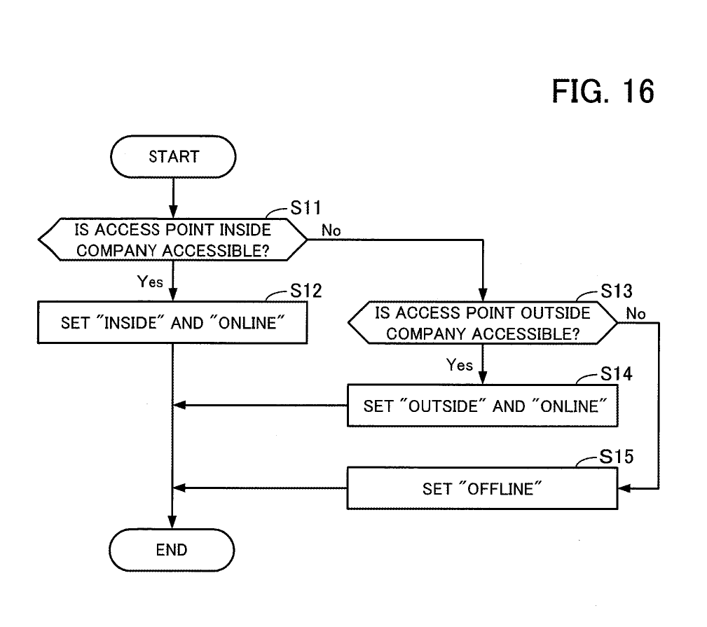

FIG. 16 is a flowchart illustrating an example of inside-or-outside-company determination by clients. In the following, the process of FIG. 16 will be described in the order of step numbers. Although the mobile phone 200 is taken as an example in the following, the same processing procedure is executed by other clients as well. The following process is executed immediately after the power supply of a client is turned on, and at predetermined intervals (for example, 3 minute interval) after the power supply is turned on.

(S11) The monitor unit 220 determines whether or not the access point 21 inside the company is accessible. If accessible, the process proceeds to step S12. If not accessible, the process proceeds to step S13. Accessible means that communication is able to be established with the access point 21. Not accessible means that communication is unable to be established with the access point 21, because a sufficient strength of electromagnetic wave is unable to be transmitted and received due to the physical distance from the access point 21.

(S12) The monitor unit 220 sets information indicating that the mobile phone 200 is inside the company and in an online state, in the terminal status management table 211. Specifically, the monitor unit 220 sets “inside” in the column of position, and “online” in the column of state. The monitor unit 220 notifies the management server 100 of the updated presence information. In response to the notification, the presence management unit 120 updates the information of the mobile phone 200 in the presence management table 112. Specifically, the presence management unit 120 sets “inside” in the column of position of mobile phone, and “online” in the column of state of mobile phone, with respect to the user carrying the mobile phone 200. Then, the process ends.

(S13) The monitor unit 220 determines whether or not the access point 11 outside the company is accessible. If accessible, the process proceeds to step S14. If not accessible, the process proceeds to step S15. Accessible means that communication is able to be established with the access point 11. Not accessible means that communication is unable to be established with the access point 11, because a sufficient strength of electromagnetic wave is unable to be transmitted and received due to the physical distance from the access point 11.

(S14) The monitor unit 220 sets information indicating that the mobile phone 200 is outside the company and in an online state, in the terminal status management table 211. Specifically, the monitor unit 220 sets “outside” in the column of position, and “online” in the column of state. The monitor unit 220 notifies the management server 100 of the updated presence information. In response to the notification, the presence management unit 120 updates the information of the mobile phone 200 in the presence management table 112. Specifically, the presence management unit 120 sets “outside” in the column of position of mobile phone, and “online” in the column of state of mobile phone, with respect to the user carrying the mobile phone 200. Then, the process ends.

(S15) The monitor unit 220 sets information indicating that the mobile phone 200 is in an offline state, in the terminal status management table 211. Then, the process ends.

As described above, whether each client is currently inside or outside the company is determined based on whether the management server 100 is accessible via the access point 11 or the access point 21. This information of “whether inside or outside the company” may be also regarded as an example of information of a current position. Clients that are unable to access the management server 100 are managed as in an offline state by the management server 100. Note that, when the monitor unit 220 has notified the management server 100 of an online state in steps S12 and S14, the monitor unit 220 may notify the management server 100 of transition to an offline state when turning off the power supply of the mobile phone 200, or when turning off the communication function of the mobile phone 200. Thereby, the management server 100 manages the mobile phone 200 as being in an offline state.

The management server 100 sets “outside” in the column of whereabouts of the presence management table 112, when any of the records including the position of PC, the position of mobile phone, and the position of tablet device is “outside” with respect to a certain user. On the other hand, the management server 100 sets “inside” in the column of whereabouts, when all of the records including the position of PC, the position of mobile phone, and the position of tablet device are “inside” with respect to a certain user. Note that positions of clients not owned by the user, and positions of clients in an offline state are not taken into consideration. Next, an example of monitoring of acceleration and position by clients will be described.

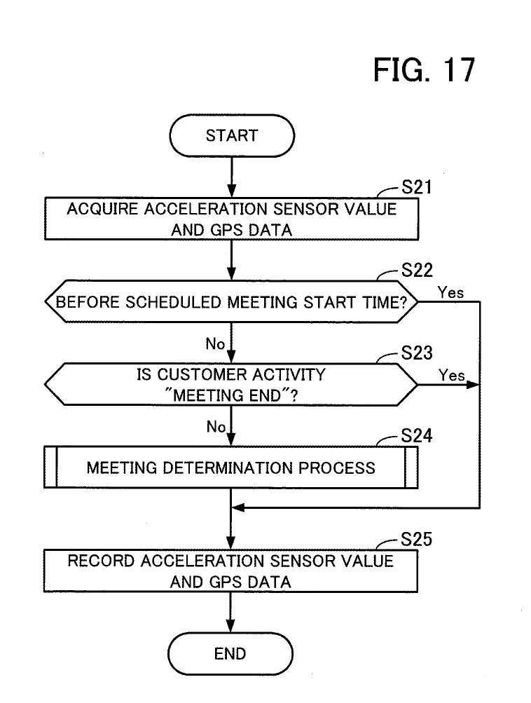

FIG. 17 is a flowchart illustrating an example of monitoring of acceleration and position by clients. In the following, the process of FIG. 17 will be described in the order of step numbers. Although the mobile phone 200 is taken as an example in the following, the same processing procedure is executed for other clients as well. Also, the following process is executed at predetermined intervals (for example, 3 minute intervals).

(S21) The monitor unit 220 acquires an acceleration sensor value detected by the acceleration sensor 207 and position information (GPS data) detected by the GPS receiver unit 208.

(S22) The monitor unit 220 determines whether or not the current time is before a scheduled meeting start time, with reference to the time management table 212. If the current time is before the scheduled meeting start time, the process proceeds to step S25. If the current time is not before the scheduled meeting start time (in other words, if the current time is at or after the scheduled meeting start time), the process proceeds to step S23. Note that, in some cases, a scheduled meeting start time is not set in the time management table 212. In such cases, the process skips the determination of step S22 and proceeds to step S25.

(S23) The monitor unit 220 determines whether or not the record of the customer activity of the user having the mobile phone 200 is “meeting end”, with reference to the terminal status management table 211. If the record is “meeting end”, the process proceeds to step S25. If the record is not “meeting end”, the process proceeds to step S24.

(S24) The monitor unit 220 executes a meeting determination process. The detail of the process will be described later.

(S25) The monitor unit 220 records the acceleration sensor value and the GPS data acquired in step S21, in the measurement table 213. Also, the monitor unit 220 transmits the GPS data acquired in step S21 to the management server 100. The presence management unit 120 records the transmitted GPS data in the position information table 113.

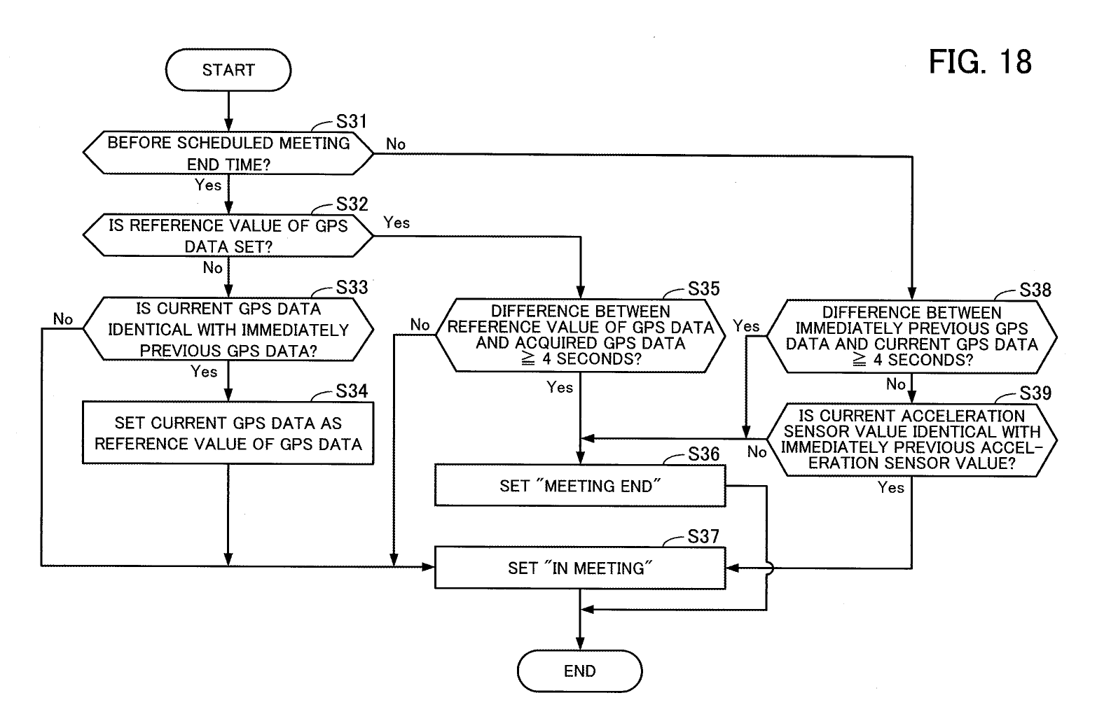

FIG. 18 is a flowchart illustrating an example of meeting determination by clients. In the following, the process of FIG. 18 will be described in the order of step numbers. The process illustrated in FIG. 18 corresponds to step S24.

(S31) The monitor unit 220 determines whether the current time is before a scheduled meeting end time, with reference to the time management table 212. If the current time is before the scheduled meeting end time, the process proceeds to step S32. If the current time is not before the scheduled meeting end time (in other words, if the current time is at or after the scheduled meeting end time), the process proceeds to step S38.

(S32) The monitor unit 220 determines whether or not a pair of reference values of GPS data is set, with reference to the reference value table 214. If a pair of reference values of GPS data is set, the process proceeds to step S35. If a pair of reference values of GPS data is not set, the process proceeds to step S33.

(S33) The monitor unit 220 determines whether or not the current GPS data acquired in step S21 is identical with the immediately previous GPS data recorded in the measurement table 213, allowing a predetermined tolerance. If the current GPS data is identical with the immediately previous GPS data with a predetermined tolerance, the process proceeds to step S34. If the current GPS data is not identical with the immediately previous GPS data with a predetermined tolerance, the process proceeds to step S37. The immediately previous GPS data is the GPS data having the latest time (time stamp) among the GPS data records recorded in the measurement table 213.

(S34) The monitor unit 220 sets the GPS data acquired in step S21 in the reference value table 214. Then, the process proceeds to step S37.

(S35) The monitor unit 220 determines whether the difference between the GPS data recorded in the reference value table 214 and the GPS data acquired in step S21 is equal to or larger than 4 seconds. If the difference is equal to or larger than 4 seconds, the process proceeds to step S36. If the difference is not equal to or larger than 4 seconds, the process proceeds to step S37. Here, the difference of 4 seconds in latitude or longitude corresponds to approximately 100 m. The monitor unit 220 may determine whether or not the difference is equal to or larger than 4 seconds in one of latitude and longitude. Alternatively, the monitor unit 220 may determine whether or not the sum of differences in both of latitude and longitude is equal to or larger than 4 seconds.

(S36) The monitor unit 220 sets “meeting end” in the column of customer activity of the terminal status management table 211. The monitor unit 220 notifies the management server 100 of the updated presence information. In response to the notification, the presence management unit 120 updates the information of the mobile phone 200 in the presence management table 112. Specifically, “meeting end” is set in the column of customer activity of the mobile phone of user U1. Then, the process ends.

(S37) The monitor unit 220 sets “in meeting” in the column of customer activity of the terminal status management table 211. The monitor unit 220 notifies the management server 100 of the updated presence information. In response to the notification, the presence management unit 120 updates the information of the mobile phone 200 in the presence management table 112. Specifically, “in meeting” is set in the column of customer activity of the mobile phone of user U1. Then, the process ends.

(S38) The monitor unit 220 determines whether the difference between the current GPS data acquired in step S21 and the immediately previous GPS data in the measurement table 213 is equal to or larger than 4 seconds. If the difference is equal to or larger than 4 seconds, the process proceeds to step S36. If the difference is not equal to or larger than 4 seconds, the process proceeds to step S39. The immediately previous acceleration sensor value is the acceleration sensor value having the latest time (time stamp) among the acceleration sensor value records recorded in the measurement table 213.

(S39) The monitor unit 220 determines whether the current acceleration sensor value acquired in step S21 and the immediately previous acceleration sensor value in the measurement table 213 are identical with each other, allowing a predetermined tolerance. If the two acceleration sensor values are not identical with each other with a predetermined tolerance, the process proceeds to step S36. If the two acceleration sensor values are identical with each other with a predetermined tolerance, the meeting is assumed to be extended, and the process proceeds to step S37. In the same way as the determination of difference of GPS data, the determination of step S39 is also performed by determining whether the difference between the current acceleration sensor value and the immediately previous acceleration sensor value is equal to or larger than a predetermined threshold value. That is, if the difference between the current acceleration sensor value and the immediately previous acceleration sensor value is equal to or larger than a predetermined threshold value, the monitor unit 220 determines that both acceleration sensor values are not identical with each other. If the difference between the current acceleration sensor value and the immediately previous acceleration sensor value is smaller than a predetermined threshold value, the monitor unit 220 determines that both acceleration sensor values are identical with each other.

In this way, the monitor unit 220 determines the meeting situation of user U1 carrying the mobile phone 200. Also, even after the scheduled meeting end time, “in meeting” is recorded as the presence when changes of the position information and the acceleration are small. Thereby, another user recognizes the extension of a meeting. Note that, after setting “meeting end”, the management server 100 resets the customer activity to no entry “-”, for example, when a user returns to a company, or when a predetermined time has passed.

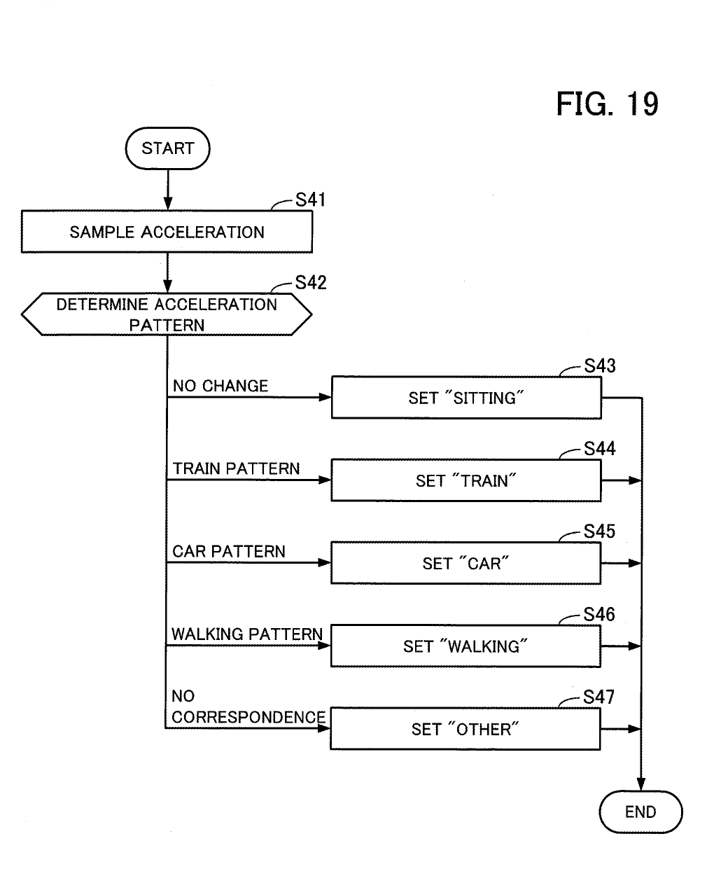

FIG. 19 is a flowchart illustrating an example of determination of travel statuses of clients. In the following, the process of FIG. 19 will be described in the order of step numbers. Although the mobile phone 200 is taken as an example in the following, the same processing procedure is executed for other clients as well. Also, the following process is executed at predetermined intervals (for example, 3 minute intervals).

(S41) The monitor unit 220 samples acceleration sensor values measured by the acceleration sensor 207.

(S42) The monitor unit 220 determines which means for traveling is utilized, on the basis of magnitude and time of acceleration, using the acceleration pattern information 215, 216, and 217 stored in the storage unit 210. If the acceleration does not change, the process proceeds to step S43. If the measured acceleration corresponds to the acceleration pattern information 215, the process proceeds to step S44. If the measured acceleration corresponds to the acceleration pattern information 216, the process proceeds to step S45. If the measured acceleration corresponds to the acceleration pattern information 217, the process proceeds to step S46. If the measured acceleration does not correspond to any acceleration pattern information, the process proceeds to step S47.

(S43) The monitor unit 220 sets “sitting” in the column of travel status of the terminal status management table 211. The monitor unit 220 notifies the management server 100 that the travel status of user U1 is “sitting”. Then, the process ends.

(S44) The monitor unit 220 sets “train” in the column of travel status of the terminal status management table 211. The monitor unit 220 notifies the management server 100 that the travel status of user U1 is “train”. Then, the process ends.

(S45) The monitor unit 220 sets “car” in the column of travel status of the terminal status management table 211. The monitor unit 220 notifies the management server 100 that the travel status of user U1 is “car”. Then, the process ends.

(S46) The monitor unit 220 sets “walking” in the column of travel status of the terminal status management table 211. The monitor unit 220 notifies the management server 100 that the travel status of user U1 is “walking”. Then, the process ends.

(S47) The monitor unit 220 sets “other” in the column of travel status of the terminal status management table 211. The monitor unit 220 notifies the management server 100 that the travel status of user U1 is “other”. Then, the process ends.

As described above, the monitor unit 220 regularly acquires the travel status of user U1 and notifies the management server 100 of the travel status of user U1. In response to the notification, the management server 100 changes the setting of the travel status of user U1 in the presence management table 112.

When the record of the position of the mobile phone in the terminal status management table 211 is “outside”, the monitor unit 220 executes the above determination of travel statuses. When the record of the position of the mobile phone in the terminal status management table 211 is “inside”, the monitor unit 220 does not execute the above determination of travel statuses. This reduces the processing load when the mobile phone 200 is inside the company, and thereby cuts back on the electric power consumption. Note that, if it is preferable to monitor a travel status inside a company, the above determination of the travel status may be executed even when the setting of position is “inside”.

Further, the monitor unit 220 may update records in the terminal status management table 211 all at once, by simultaneously executing the processes of FIGS. 17 to 19. The monitor unit 220 may notify the management server 100 of the updated records of the terminal status management table 211, when the records of the terminal status management table 211 are updated.

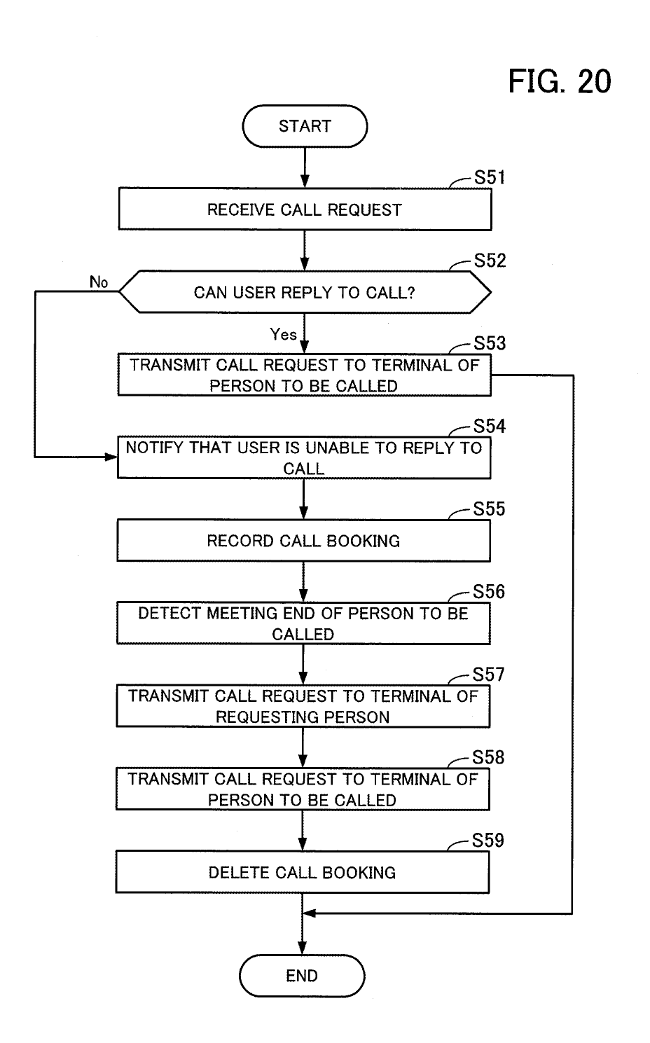

FIG. 20 is a flowchart illustrating an example of a call process by the management server. In the following, the process of FIG. 20 will be described in the order of step numbers. Although, in the following description, a call to users U1 and U2 by means of the PC 300 and the mobile phone 200 is taken as an example, a call to users may be executed in the same way by means of other clients.

(S51) The call unit 130 receives a call request to the mobile phone 200, from the PC 300. The call request includes information such as identification information (device number) of the PC 300, the user ID of user U2, identification information of the mobile phone 200, and the user ID of user U1. The call request includes information specifying a message transmission method (for example, voice call, video meeting, text chat, etc.).

(S52) The call unit 130 determines whether user U1 who is to be called is in a situation in which user U1 is able to reply to a call, with reference to the presence of user U1 in the presence management table 112. Specifically, if the customer activity of user U1 is not “in meeting”, user U1 is able to reply to a call. If the customer activity of user U1 is “in meeting”, user U1 is unable to reply to a call. If user U1 is able to reply to a call, the process proceeds to step S53. If user U1 is unable to reply to a call, the process proceeds to step S54.

(S53) The call unit 130 transmits a call request to the mobile phone 200. The mobile phone 200 calls up user U1 by calling sound, vibration, or other method, in response to the call request. If user U1 manipulates the mobile phone 200 to reply to the call, the call unit 130 receives the reply to the call request from the mobile phone 200. Then, the call unit 130 establishes connection between the mobile phone 200 and the PC 300. Then, transmission of messages starts between users U1 and U2 by means of the mobile phone 200 and the PC 300. The transmission method is the method specified by the PC 300. Then, the process ends.

(S54) The call unit 130 notifies the PC 300 that user U1 who is to be called is unable to reply to the call.

(S55) The call unit 130 accepts an instruction to record a call booking, from the PC 300. The call unit 130 records the call booking, which is requested from the PC 300 for the mobile phone 200, in the call booking table 115. This call request is the call request to user U1 from user U2. The call unit 130 monitors the change of the customer activity of user U1 in the presence management table 112.

(S56) The call unit 130 detects that the customer activity of user U1 changes from “in meeting” to “meeting end”, with reference to the presence management table 112.

(S57) The call unit 130 transmits a call request to the PC 300 of user U2, who is the requesting person, with reference to the call booking table 115. The PC 300 calls up user U2 by calling sound, vibration, or other method, in response to the call request. If user U2 manipulates the PC 300 to reply to the call, the call unit 130 accepts a reply to the call request from the PC 300. At this time, the call unit 130 also accepts information specifying a message transmission method (for example, voice call, video meeting, text chat, etc.).

(S58) The call unit 130 transmits a call request to the mobile phone 200 of user U1 who is to be called, with reference to the call booking table 115. The mobile phone 200 calls up user U1 by calling sound, vibration or other method, in response to the call request. If user U1 manipulates the mobile phone 200 to reply to the call, the call unit 130 receives the reply to the call request from the mobile phone 200. Then, the call unit 130 establishes connection between the mobile phone 200 and the PC 300. Then, transmission of messages starts between users U1 and U2 by means of the mobile phone 200 and the PC 300. The transmission method is the method specified by the PC 300.

(S59) The call unit 130 deletes the call booking that has been executed, from the call booking table 115. Then, the process ends.

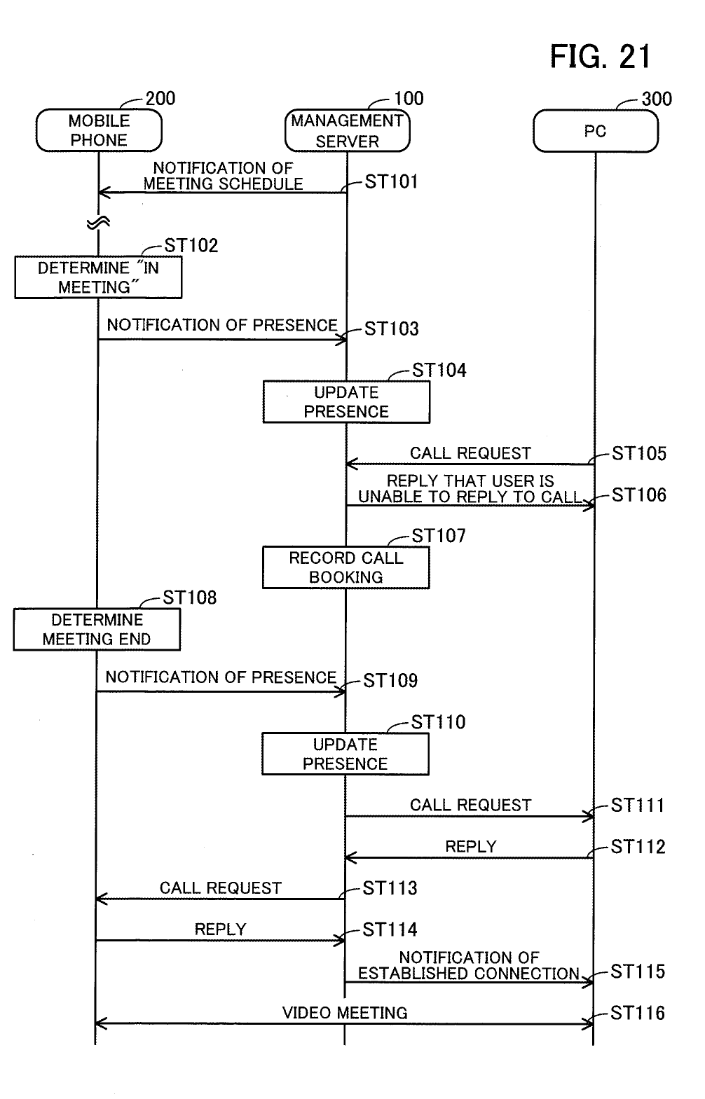

FIG. 21 is a sequence diagram illustrating an example of the sequence of the call process. In the following, the process of FIG. 21 will be described in the order of step numbers. Also, in the following description, a call request that requests a video meeting is transmitted from the PC 300 to the management server 100. The following description will explain the sequence that establishes communication by video meeting between the PC 300 of the requesting person (user U2) and the mobile phone 200 of the person who is to be called (user U1).

(ST101) The management server 100 notifies the mobile phone 200 of a meeting schedule. Step ST101 may be executed when the mobile phone 200 logs in to the management server 100 for the first time, or when the schedule recorded in the management server 100 is changed, for example. The mobile phone 200 records the meeting schedule of user U1 in the time management table 212.

(ST102) The mobile phone 200 continually monitors the presence of user U1, by the processes of FIGS. 16 to 19. Upon detecting arrival of a scheduled meeting start time recorded in the time management table 212, the mobile phone 200 determines that the customer activity of user U1 is “in meeting”. The mobile phone 200 sets “in meeting” in the customer activity of the terminal status management table 211.

(ST103) The mobile phone 200 notifies the management server 100 of the presence (“in meeting” of the customer activity) after update.

(ST104) The management server 100 updates the customer activity of user U1 in the presence management table 112 to “in meeting”.

(ST105) The PC 300 transmits a call request of a video meeting with the mobile phone 200, to the management server 100. For example, when user U2 wants to have a video meeting with user U1, user U2 operates the PC 300 to transmit a call request from the PC 300 to the management server 100.

(ST106) The management server 100 replies, to the PC 300, that user U1 is unable to reply to a call due to “in meeting” set as the customer activity of user U1, with reference to the presence management table 112.

(ST107) The management server 100 records a booking of a call from the PC 300 to the mobile phone 200 in the call booking table 115. In this case, a call is booked by the PC 300 for the management server 100. As illustrated in step S55 of FIG. 20, in response to the reply of step ST106, the management server 100 may accept an instruction to make a call booking from the PC 300 and then execute present step ST107.

(ST108) The mobile phone 200 determines that the customer activity of user U1 has changed to “meeting end”, in accordance with the process of FIG. 18. The mobile phone 200 sets “meeting end” in the customer activity of the terminal status management table 211.

(ST109) The mobile phone 200 notifies the management server 100 of the presence (“meeting end” of the customer activity) after update.

(ST110) The management server 100 updates the customer activity of user U1 in the presence management table 112 to “meeting end”.

(ST111) The management server 100 transmits a call request for user U2 to the PC 300. The PC 300 calls up user U2 by calling sound and vibration.

(ST112) The PC 300 accepts operation for replying to the call to user U2. At this time, the PC 300 accepts selection of a message transmission method, from user U2. Here, video meeting is assumed to be selected. Then, the PC 300 transmits a reply to the call, to the management server 100. This reply includes information indicating that user U2 has selected video meeting as the message transmission method.

(ST113) The management server 100 transmits a call request for user U1 to the mobile phone 200. The mobile phone 200 calls up user U1 by calling sound and vibration.

(ST114) The mobile phone 200 accepts operation for replying to the call to user U1. Then, the mobile phone 200 transmits a reply to the call, to the management server 100.

(ST115) The management server 100 notifies the PC 300 that connection is established for a video meeting.

(ST116) The PC 300 and the mobile phone 200 starts communication for the video meeting. Thereafter, the video meeting starts between users U1 and U2.

As described above, even in the situation where user U1 is in a meeting with a customer and is unable to be called using the mobile phone 200, the management server 100 records a call booking and monitors the availability of user U1. Then, the management server 100 executes the booked call to users U1 and U2 by means of the mobile phone 200 and the PC 300, in response to change of the availability of user U1.

Further, although, in step S52 of FIG. 20, whether or not a user is able to reply to a call is determined on the basis of the customer activity of the user, whether or not a user is able to reply to a call may be determined, for example, on the basis of the travel status of the user. Specifically, it may be determined that a user is able to reply to a call, when the travel status of the user is “walking” or “sitting”. In addition, it may be determined that a user is unable to reply to a call, when the travel status of the user is “train” or “car”. This is because behavior such as talking on a phone is ill-mannered in a public transportation system, such as “train”. Also, this is because a user is unable to transmit a message, while driving a car.

Also, in step S56 of FIG. 20, whether or not a user is able to reply to a call may be determined on the basis of both of the customer activity and the travel status of the user. For example, if the travel status is “train” or “car” when the customer activity changes to “meeting end”, the execution of a call of step S57 in FIG. 20 may be delayed until the travel status changes to “walking” or “sitting”.

Also, when transmitting a call request to the PC 300 in step S57 of FIG. 20, the call unit 130 may select a message transmission method on the basis of the availability of user U1. For example, when the travel status of user U1 is “train”, the communication is assumed to be not allowed with voice call or video meeting, but allowed with text chat. In this case, the call unit 130 may select text chat for example, as the message transmission method, to allow users U1 and U2 to start transmitting their messages.

Note that the management server 100 may decide when to execute a booked call in additional consideration of the availability of the requesting user U2. In the following, such function is described.

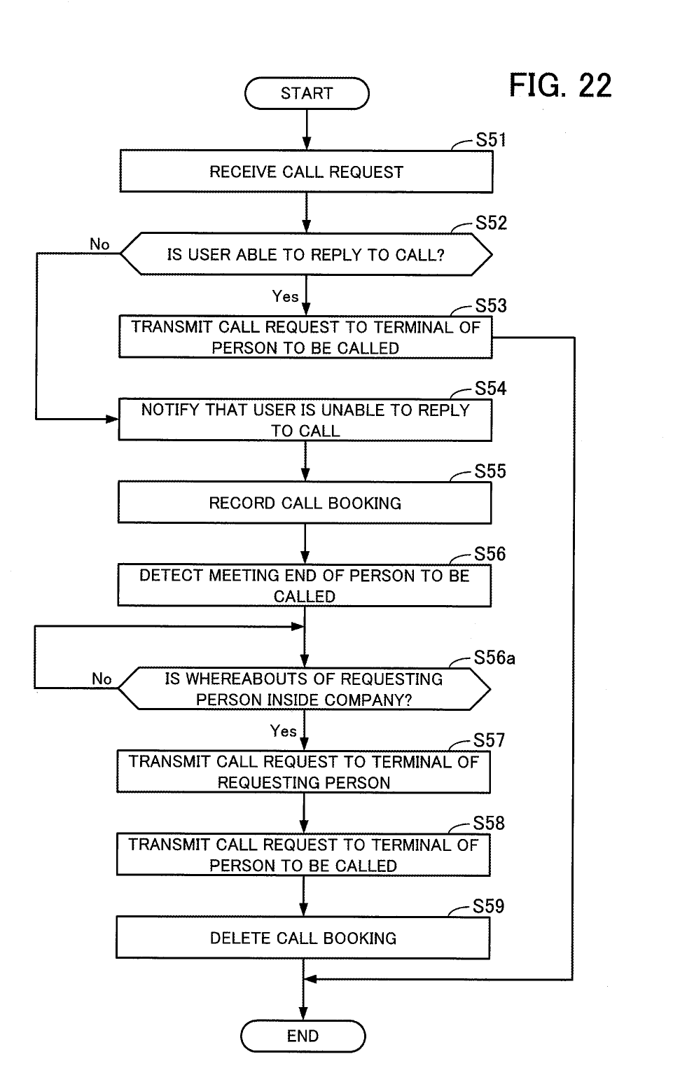

FIG. 22 is a flowchart illustrating another example of call process by the management server. In the following, the process of FIG. 22 will be described in the order of step numbers. Although, in the following description, a call to users U1 and U2 by means of the PC 300 and the mobile phone 200 is taken as an example, a call to users may be executed in the same way by means of other clients. Here, the procedure of FIG. 22 is obtained by adding step S56a in the procedure of FIG. 20. Specifically, the management server 100 executes step S56a after step S56 and executes step S57 in response to the determination result of step S56a. Accordingly, the following description will focus on step S56a, without repeating previous explanations for other steps.

(S56a) The call unit 130 determines whether or not the whereabouts of the requesting user U2 is inside a company, with reference to the presence management table 112. If the whereabouts is inside the company, the process proceeds to step S57. If the whereabouts is not inside the company (in other words, outside the company), the process proceeds to step S56a (to wait until user U2 returns to the company from outside).

As described above, the management server 100 may decide when to execute a booked call, in consideration of the schedules of both users U1 and U2. This is because a requesting person sometimes goes out from the company after booking a call, for example. Note that the determination of step S56a may be executed on the basis of position information acquired by the client utilized by user U2. For example, it is determined that user U2 is inside the company when the position information corresponds to a position inside the office. It is determined that user U2 is outside the company when the position information does not correspond to a position inside the office.

Also, in step S56a, the PC 300 is sometimes in an offline state, even when user U2 is present inside the company. Thus, when executing a booked call (step S58), the call unit 130 may select a client in an online state from among the clients utilized by user U2 and request the selected client to call up user U2. Further, the management server 100 may select a method for transmitting messages, on the basis of the availability of a client that user U2 utilizes, (for example, the management server 100 selects voice call, when only the mobile phone is utilizable).

As described above, the management server 100 executes booked calls at more appropriate times. For example, one can conceive of determining the availability of user U1, using position information of the mobile phone 200, but the accuracy of determining the availability of user U1 might deteriorate in this case. This is because the position information alone is sometimes insufficient for understanding actual behavior of user U1. For example, even in a customer's office, continual moving around might lead to a determination of unbusy situation. Thus, the management server 100 executes a call, when a meeting of user U1 is determined to have ended on the basis of position information (GPS data) and acceleration information (acceleration sensor value) acquired by the mobile phone 200. For example, as illustrated in FIG. 18, the mobile phone 200 also determines whether or not a meeting is extended on the basis of the position information and the acceleration information, and notifies the management server 100 of the determination result. Hence, the management server 100 executes a call to users U1 and U2 at a more appropriate time.

Communication is smoothly started by calling up user U2 owning the PC 300 and user U1 carrying the mobile phone 200, in response to the user's availability determined as described above. At this time, both of the users are called, and thus user U2 owning the PC 300 is not forced to take effort to continually confirm the availability of user U1 carrying the mobile phone 200.

Also, although the second embodiment describes a case where messages are transmitted between two users, the same processing may be applied to a case where messages are transmitted between three or more users. Such case is, for example, a situation where one user calls a plurality of users at a certain time to have a telephone meeting. If any of the called users is busy (for example, in meeting), the management server 100 records a call booking in which the requesting user and the called users are set as users who are to be called for a telephone meeting. Then, when the busy user is relieved from the busy situation, all of the recorded users are called to start the telephone meeting. As described above, when three or more users transmit messages, all users are called at an appropriate time, so that communication is smoothly started.

Note that, as described above, the information processing of the first embodiment is performed by causing the computing unit 1b to execute a program. Also, the information processing of the second embodiment is performed by causing the processor of the management server 100 to execute a program. Those programs are recorded in a computer-readable recording medium (for example, the optical disc 33, the memory device 34, the memory card 36, etc.).

When putting a program on the market, a portable recording medium having the program recorded thereon is provided, for example. Also, the program may be stored in a storage device of another computer, so as to be distributed via a network. For example, the computer stores the program that is recorded in a portable recording medium or received from another computer, in a storage device, and reads the program from the storage device to execute it. Note that the program read from a portable recording medium or received from another computer via a network may be directly executed. In one aspect, users are called at appropriate times.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A call method of calling up users at start of message transmission in a system including a plurality of devices utilized by a plurality of users and an information processing apparatus configured to support transmission of a message between the users by means of the devices, the method comprising:
booking, by a first device utilized by a first user, a call to the first user and a second user by means of the first device and a second device utilized by the second user, in the information processing apparatus;
detecting, by the second device, a current position and an acceleration of the second device to determine an availability of the second user based on the current position and the acceleration; and
acquiring, by the information processing apparatus, the availability of the second user and executing the booked call in response to a change of the availability of the second user.

2. The call method according to claim 1, wherein
the second device determines whether or not a scheduled activity of the second user has ended, based on schedule information of the second user, the current position, and the acceleration, and
the information processing apparatus executes the call when the scheduled activity of the second user has ended.

3. The call method according to claim 2, wherein
the second device determines that the scheduled activity has ended, when a current time is at or after a scheduled end time of the scheduled activity of the second user and a difference between a previous position and a current position is equal to or larger than a first threshold value, and when the difference between the previous position and the current position is smaller than the first threshold value and a difference between a previous acceleration and a current acceleration is equal to or larger than a second threshold value, and determines that the scheduled activity has not ended, when the difference between the previous position and the current position is smaller than the first threshold value and the difference between the previous acceleration and the current acceleration is smaller than the second threshold value.

4. The call method according to claim 1, wherein
the information processing apparatus acquires an availability of the first user determined by the first device, and
the information processing apparatus executes the call in response to a change of the availabilities of the first and second users.

5. The call method according to claim 1, wherein
the second device determines what means for traveling is utilized by the second user in an area, and
the information processing apparatus executes the call by a method corresponding to the means for traveling utilized by the second user.

6. The call method according to claim 1, wherein
the information processing apparatus selects a method for transmitting the message, based on an availability of the first user or the availability of the second user determined when the call is executed.

7. An information processing apparatus that supports transmission of a message between users by means of a plurality of devices, comprising:
a memory configured to store booking information of a call to a first user and a second user by means of a first device utilized by the first user and a second device utilized by the second user; and
a processor configured to perform a procedure including:
storing the booking information acquired from the first device in the memory,
acquiring an availability of the second user determined based on a current position and an acceleration of the second device, from the second device, and
executing the booked call in response to a change of the availability of the second user.

8. A non-transitory computer-readable storage medium storing a call program that causes a computer to perform a process for supporting transmission of a message between users by means of a plurality of devices, the process comprising:
acquiring booking information of a call to a first user and a second user by means of a first device utilized by the first user and a second device utilized by the second user, from the first device;
acquiring an availability of the second user determined based on a current position and an acceleration of the second device, from the second device; and
executing the booked call in response to a change of the availability of the second user.
